(19) United States
(12) Patent Application Publication
(10) Pub. No.: US 2002/0003641 A1
(43) Pub. Date: Jan. 10, 2002

(54) Polarization division multiplexer

(76) Inventors: Katherine L. Hall, Westford, MA (US); Michael LaGasse, Lexington, MA (US); Hemonth Rao, Burlington, MA (US); Barry Romkey, Burlington, MA (US)

Correspondence Address: LAW OFFICES OF KURT RAUSCHENBACH, POST OFFICE BOX 387, BEDFORD, MA, 01730, US

(21) Appl. No.: 09/782,569

(22) Filed: Feb. 13, 2001

Related U.S. Application Data
(63) Continuation-in-part of application No. 09/566,303, filed on May 8, 2000.

(51) Int. Cl. H04J 14/06; H04J 14/08

(52) U.S. Cl. 359/122; 359/135

(57) ABSTRACT

A bit interleaved polarization multiplexer is described that includes a first and a second modulator. The first and the second modulator modulate a first and a second electrical modulation signal, respectively, onto an optical signal and generate a modulated optical pulse train at a first and a second optical output, respectively. An optical beam combiner combines the modulated optical bit stream generated by the first and the second modulators into a polarization multiplexed optical pulse train. A relative position of each pulse in the polarization multiplexed optical pulse train is determined by an optical path length propagated by the pulse and a relative order of each pulse in the polarization multiplexed optical pulse train is determined by a relative phase of the modulation signal that generated the pulse.

### RELATED APPLICATIONS

This is a continuation-in-part of patent application Ser. No. 09/566,303, filed on May 8, 2000, the entire disclosure of which is incorporated herein by reference.

### FIELD OF THE INVENTION

The present invention relates to optical multiplexing in single and multi-wavelength systems. In particular, the present invention relates to methods and apparatus for multiplexing in optical time-division multiplexing communication systems and hybrid optical time-division multiplexing/wavelength-division multiplexing communication systems.

### BACKGROUND OF THE INVENTION

Optical Time-Division Multiplexing (OTDM) communication systems can transmit data in a single optical channel at ultra-high bit rates. Functionally OTDM is identical to electronic TDM. Bits associated with different channels are interleaved in the time domain to form a bit interleaved bit stream. In operation, OTDM transmitters multiplex several lower-speed optical bit streams modulated at bit rate R to form a bit interleaved optical bit stream modulated at bit rate RN, where N is the number of multiplexed optical channels. OTDM receivers receive the bit interleaved optical bit stream at bit rate NR and extract the lower-speed optical bit streams modulated at bit rate R. OTDM transmitters and receivers use high-speed optical multiplexing and demultipexing techniques.

FIG. 1 illustrates a schematic diagram of a prior art bit interleaved OTDM transmitter 10 that uses optical multiplexing to multiplex N data channels with synchronized electrical modulation signals. A laser 12 generates an optical clock signal that comprises a periodic pulse train having a repetition rate equal to a single-channel bit rate R and at a pulse width TAₚ, where Tₚ is less than (NR)⁻¹ to ensure that each pulse can be positioned in its allocated time slot. An optical splitter 14, such as a 1XN fused fiber coupler, splits the laser output equally into N channels or arms 16 and directs each of the arms 16 to an electro-optic modulator 18.

The electro-optic modulator 18 in each arm 16 is modulated by a synchronized electrical modulation signal that is generated by an electrical modulation source 19. That is, the modulators 18 are modulated by electrical modulation signals that are substantially synchronized with each other. By substantially synchronized, we mean that the electrical modulation signals have substantially the same relative phase. In operation, each of the modulators 18 blocks the pulse for every “0” bit and passes the pulse for every “1” bit, thereby creating N independent bit streams propagating at the bit rate R.

Multiplexing of N bit streams is achieved by an optical delay technique. An optical delay 20 is inserted into each arm 16 after the modulator 18. Each of the optical delays has a predetermined precision optical time delay that is different from each of the other optical time delays. One arm may not have an optical delay other than an optical delay associated with an optical waveguide that couples the modulator to the output of the OTDM transmitter 10, as illustrated in FIG. 1. The optical delay 20 delays the modulated bit stream in the n^{th} arm by an amount equal to (n−1)/(RN). An optical combiner 22 recombines the output of the N arms 16 to form a bit interleaved optical bit stream. The bit interleaved optical bit stream is a multiplexed bit stream where each bit is positioned in a time slot T_{R}=(NR)⁻¹.

One type of prior art OTDM multiplexer is fabricated with single-mode optical fiber and a lithium niobate or semiconductor waveguide modulator. The lengths of the single-mode optical fiber in each of the arms 16 must be precisely controlled in order to achieve the correct relative time delays in each arm 16. For example, a 40 Gb/s OTDM signal may require that the length of the fiber be controlled to within 20 microns. As the data rate of OTDM signals increases, it becomes more difficult to adequately control the length of the fiber or optical waveguide in each arm 16 with the required precision.

It has been proposed that OTDM multiplexers be fabricated with planar lightwave circuits fabricated with silica-on-silicon technology. Such a multiplexer is advantageous because the optical delays can be precisely controlled. However, in G. P. Agrawal, Fiber-Optic Communication Systems, Wiley, 1997, pp. 330-331, it is noted that it is difficult to build the entire multiplexer on a planar lightwave circuit, since modulators cannot be integrated with this technology.

Generally, it is possible to achieve precise path length differences in planar lightwave circuits fabricated using silica planar technology. This is because the lengths are defined by photolithography. Tight bends are allowed because of the relatively large refractive index difference between the waveguide and the substrate. However, it is difficult to achieve large relative differential delays (25-50 ps) in lithium niobate (and other commonly used electro-optic materials) because the refractive index of the waveguide material is very similar to the refractive index of the substrate material and, therefore, a tight bending radius is not possible. This constraint and the maximum physical size of the wafer makes it difficult to integrate OTDM multiplexers using known lithium niobate technology.

### SUMMARY OF THE INVENTION

The present invention relates to optical multiplexing and to OTDM transmitters that can be used for high-speed optical communications. In one embodiment, optical mulitplexers and OTDM transmitters according to the present invention do not require precision optical fiber or optical waveguide lengths. OTDM transmitters according to the present invention can perform channel marking, bit interchanging, channel dropping, packet multiplexing, and multi-rate OTDM transmission.

One advantage of the present invention is that a high-speed OTDM transmitter can be fabricated without the necessity to implement very small differences in the optical delays between the various arms. In one embodiment, this advantage is achieved by using electrical modulation signals that are unsynchronized relative to each other as described herein. In another embodiment, this advantage is achieved by using variable optical delays. Another advantage of the present invention is that a high-speed OTDM transmitter can be constructed that performs channel dropping and multi-rate transmission.

Yet another advantage of the present invention is that a bit interleaved polarization multiplexer can be constructed for high-speed data transmission. Such a polarization multiplexer has numerous advantages. One advantage of the polarization multiplexer of the present invention is that it has relatively high spectral efficiency because data propagates in two orthogonally polarized pulse trains at a single wavelength. Other advantages of the multiplexer are that the dispersion tolerance is significantly increased and timing jitter is significantly reduced because adjacent bits in the bit interleaved pulse train are orthogonally polarized.

Accordingly, the present invention features a polarization division multiplexer that includes a first and a second modulator. The modulators may be Mach-Zehnder interferometric modulators, electro-optic modulators, or electro-absorption modulator. The modulators may also be pulse carving modulators that generate optical clock signals. Each of the first and the second modulators has an optical input that receives an optical signal from an optical source, such as a laser. The optical signal may be an optical clock signal that is generated by a continuous wave (CW) laser and an external modulator or a directly modulated laser. Alternatively, the optical signal may be a CW laser signal that, for example, is used by a pulse carving modulator to generate an optical clock signal. The multiplexer may include an optical splitter having an optical input that receives an optical signal and having a first and a second output that produce the optical signal. A respective one of the first and the second outputs of the optical splitter is optically coupled to an optical input of a respective one of the first and second modulators. In one embodiment, the polarization state of the optical signal is maintained by the optical splitter.

Each of the first and the second modulators also has an electrical modulation signal input that receives an electrical modulation signal that is generated by an electrical modulation source. A respective output of a first and a second modulation source is electrically coupled to an electrical modulation signal input of a respective one of the first and the second modulators. In one embodiment, one of the electrical modulation sources generates a modulation signal with a phase that is independent of the phase of modulation signal generated by the other electrical modulation source. The first and the second modulator modulate a first and a second electrical modulation signal onto the optical signal and generate a first and a second modulated optical pulse train, respectively, at an optical output of the first and the second modulator, respectively. The multiplexer also includes an optical beam combiner, which may be a polarization beam combiner, a coupler, or a polarization maintaining coupler. A respective one of the first and the second optical inputs of the optical beam combiner is optically coupled to an optical output of a respective one of the first and the second modulator. The optical beam combiner may be optically coupled to the first and the second modulator with polarization maintaining optical fiber.

The optical beam combiner combines the modulated optical bit stream generated by each of the first and the second modulators into a polarization multiplexed optical pulse train. A relative position of each pulse in the polarization multiplexed optical pulse train is determined by an optical path length that propagated the pulse and a relative order of each pulse in the polarization multiplexed optical pulse train is determined by a relative phase of the modulation signal that generated the pulse. In one embodiment, a polarization controller is optically coupled to the output of at least one of the first and the second modulators. The polarization controller alters or changes the polarization state of the modulated optical pulse train.

In one embodiment, the multiplexer includes feedback to adjust the relative position of the pulses in the polarization multiplexed optical pulse train. In this embodiment, the multiplexer includes a dither signal generator that is electrically coupled to the electrical modulation signal input of one of the first and the second modulators. The dither signal generator superimposes a dither signal on the electrical modulation signal, thereby marking the modulated optical pulse train with the dither signal.

In one embodiment, a detector is positioned to detect a portion of the polarization multiplexed optical pulse train. In another embodiment, a detector is optically coupled to a complementary output port of one of the first and the second modulators, such as the second port of a dual-output Mach-Zehnder interferometric modulator. The detector generates at an output an electrical signal having the superimposed dither signal.

An electronically variable phase delay generator receives the electrical signal generated by the detector and changes the phase of the electrical modulation signal generated by the electrical modulation source. An input of the electronically variable phase delay generator is electrically coupled to the output of the detector. An output of the electronically variable phase delay generator is electrically coupled to a control input of the electrical modulation source that drives one of the first and the second modulators.

The electronically variable phase delay generator generates a signal that changes the phase of the electrical modulation signal generated by the electrical modulation source. The phase of the electrical modulation signal can be changed to position pulses in the polarization multiplexed optical pulse train in a desired relative order. The phase may also be changed to adjust the time position of the optical signal relative to the electronic switching window. In the case where the input optical signal is a return-to-zero (RZ) or clock pulse, this function may be referred to as RZ/NRZ alignment. Typically, the electronic modulation signal is a non-return-to-zero (NRZ) format.

In one embodiment, the multiplexer includes a variable optical delay that is optically coupled between the output of at least one of the first and the second modulators and one of the first and second inputs of the optical beam combiner. The variable optical delay adjusts the relative position of the pulses in the polarization multiplexed optical pulse train. The variable optical delay may continuously adjust the relative position of the pulses in the polarization multiplexed optical pulse train. The variable optical delay may be inserted anywhere along the optical path of the multiplexer arms.

In one embodiment, the multiplexer is a combination of discrete components that are coupled together with optical fiber. The optical fiber may be polarization maintaining optical fiber. That is, the optical splitter, modulators, and optical beam combiner are optically coupled with an optical fiber. In another embodiment, the multiplexer comprises an integrated lightwave circuit where some or all of the components are integrated.

The present invention also features a method of generating a polarization multiplexed optical pulse train. The method includes modulating a first and a second optical signal with a first and a second electrical modulation signal, respectively, thereby generating a first and a second modulated optical pulse train. In one embodiment, the first and the second optical signals are substantially the same optical signal. A phase of the first electrical modulation signal is independently adjustable relative to the phase of the second electrical modulation signal.

In one embodiment, the electrical modulation signal comprises a train of electrical packets propagating at data rate R and the phase of the packets is chosen so that each bit is combined in optical packets at data rate NR, where N is the number of channels. In one embodiment, the method includes channel dropping. At least one of the first and the second optical signal is modulated with a sustained switching voltage, thereby dropping a channel.

The first and the second modulated optical pulse trains are then combined into a polarization multiplexed optical pulse train. The polarization multiplexed optical pulse train may include time overlapping polarization multiplexed optical pulses. The polarization multiplexed optical pulse train can be linearly polarized or can be orthogonally polarized. In one embodiment, the polarization multiplexed optical pulse train is substantially periodic.

A relative position of each pulse in the pulse train is determined by the optical path length propagated by the pulse. A relative order of each pulse in the pulse train is determined by a relative phase of the modulation signal that generated the pulse. The method may include adjusting a phase of one of the first or the second electrical modulation signals to change the relative order of pulses propagating in the polarization multiplexed optical pulse train.

The present invention also features another polarization division multiplexer that includes a plurality of modulators. The modulators may be Mach-Zehnder interferometric modulators, electro-optic modulators, or electro-absorption modulator. The modulators may also be pulse carving modulators that generate optical clock signals. Each of the plurality of modulators has an optical input that receives an optical signal from an optical source, such as a laser. The optical signal may be an optical clock signal that is generated by a CW laser and an external modulator or by directly modulating a CW laser. Alternatively, the optical signal may be a CW laser that, for example, is used by a pulse carving modulator to generate an optical clock signal.

The multiplexer may include an optical splitter having an optical input that receives an optical signal and having a plurality of outputs that produce the optical signal. A respective one of the plurality of outputs of the optical splitter is optically coupled to an optical input of a respective one of the plurality of modulators. In one embodiment, the polarization state of the optical signal is maintained by the optical splitter.

Each of the plurality of modulators also has an electrical modulation signal input that receives an electrical modulation signal that is generated by an electrical modulation source. A respective output of one of a plurality of modulation sources is electrically coupled to an electrical modulation signal input of a respective one of the plurality of modulators. In one embodiment, one of the electrical modulation sources generates a modulation signal with a phase that is independent of the phase of the modulation signals generated by the other electrical modulation sources. Each of the plurality of modulators modulate the electrical modulation signal onto the optical signal and generate a modulated optical pulse train at an optical output.

The multiplexer also includes at least one optical bit interleaving combiner. Each of the at least one bit interleaving combiners includes a plurality of optical inputs and an optical output. A respective one of the plurality of optical inputs of the bit interleaving combiner is optically coupled to a respective one of the optical outputs of the plurality of modulators. The at least one bit interleaving combiner generates two bit interleaved optical pulse trains at a first and a second optical output.

The multiplexer also includes an optical beam combiner having a first and a second optical input and an optical output. The beam combiner can be any beam combiner, such as a polarization beam combiner, a coupler, or a polarization maintaining coupler. A respective one of the first and the second optical input of the beam combiner is optically coupled to the first and the second optical output of the at least one bit interleaving combiners. Polarization maintaining optical fiber may be used to couple the beam combiner to the at least one of the bit interleaving combiners.

The optical beam combiner combines the modulated optical bit stream generated by each of the plurality of modulators into a polarization multiplexed optical pulse train. A relative position of each pulse in the polarization multiplexed optical pulse train is determined by an optical path length propagated by the pulse and a relative order of each pulse in the polarization multiplexed optical pulse train is determined by a relative phase of the modulation signal that generated the pulse. In one embodiment, a polarization controller is optically coupled to the output of at least one of the plurality of modulators. The polarization controller changes the polarization state of the modulated optical pulse train.

In one embodiment, the multiplexer includes feedback to adjust the relative position of the pulses in the polarization multiplexed optical pulse train. In this embodiment, the multiplexer includes a dither signal generator that is electrically coupled to the electrical modulation signal input of one of the plurality of modulators. The dither signal generator superimposes a dither signal on the electrical modulation signal, thereby marking the modulated optical pulse train with the dither signal.

In one embodiment, a detector is positioned to detect a portion of the polarization multiplexed optical pulse train. In another embodiment, a detector is optically coupled to a complementary output port of one of the plurality of modulators, such as the second port of a dual-output Mach-Zehnder interferometric modulator. The detector generates at an output an electrical signal having the superimposed dither signal.

An electronically variable phase delay generator receives the electrical signal generated by the detector and changes the phase of the electrical modulation signal generated by the electrical modulation source. An input of the electronically variable phase delay generator is electrically coupled to the output of the detector. An output of the electronically variable phase delay generator is electrically coupled to a control input of the electrical modulation source that drives one of the plurality of modulators.

The electronically variable phase delay generator generates a signal that changes the phase of the electrical modulation signal generated by the electrical modulation source that drives one of the plurality of modulators. The phase of the electrical modulation signal can be changed to position pulses in the polarization multiplexed optical pulse train in a desired relative order. Also, the phase of the electrical modulation signal can be changed to insure that the optical signal is correctly aligned or synchronized in time with the electrical modulation signal.

In one embodiment, the multiplexer includes a variable optical delay that is optically coupled between the output of one of the plurality of modulators and one of the first and second inputs of the optical beam combiner. The variable optical delay adjusts the relative position of the pulses in the polarization multiplexed optical pulse train. The variable optical delay may continuously adjust the relative position of the pulses in the polarization multiplexed optical pulse train. In another embodiment, the variable optical delay can be positioned anywhere along the optical path of the any of the plurality of arms.

The present invention also features another method of generating a polarization multiplexed optical pulse train. The method includes modulating a plurality of optical signal with a plurality of electrical modulation signal, thereby generating a plurality of optical pulse trains. In one embodiment, each of the plurality of optical signals is substantially the same optical signal. A phase of at least one of the plurality of electrical modulation signal is independently adjustable relative to the phase of the other electrical modulation signals.

In one embodiment, the electrical modulation signal comprises a train of electrical packets propagating at data rate R and the phase of the packets is chosen so that each bit is combined in optical packets at data rate NR, where N is the number of channels. In one embodiment, the method includes channel dropping. At least one of the plurality of optical signal is modulated with a sustained switching voltage, thereby dropping a channel.

The plurality of optical pulse trains are then combined into a first and a second bit interleaved optical pulse trains. The first and the second bit interleaved optical pulse trains are then combined into a polarization multiplexed optical pulse train. The polarization multiplexed optical pulse train may include time overlapping polarization multiplexed optical pulses. The polarization multiplexed optical pulse train can be linearly polarized or can be orthogonally polarized. In one embodiment, the polarization multiplexed optical pulse train is substantially periodic.

A relative position of each pulse in the pulse train is determined by the optical path length propagated by the pulse. A relative order of each pulse in the pulse train is determined by a relative phase of the modulation signal that generated the pulse. The method may include adjusting a phase of one of the plurality of electrical modulation signals to change the relative order of pulses propagating in the polarization multiplexed optical pulse train.

### BRIEF DESCRIPTION OF THE DRAWINGS

This invention is described with particularity in the appended claims. The above and further advantages of this invention may be better understood by referring to the following description in conjunction with the accompanying drawings, in which like numerals indicate like structural elements and features in various figures. The drawings are not necessarily to scale, emphasis instead being placed upon illustrating the principles of the invention.

FIG. 1 illustrates a schematic diagram of a prior art bit interleaved OTDM transmitter that uses optical multiplexing to multiplex N data channels with synchronized electrical modulation signals.

FIG. 2 illustrates a schematic diagram of a bit interleaved OTDM transmitter of the present invention that uses optical multiplexing to multiplex N channels of data that are modulated with unsynchronized electrical modulation signals.

FIG. 3 illustrates a schematic diagram of a bit interleaved OTDM transmitter of the present invention that uses optical multiplexing to optically multiplex four channels of data where the optical path propagating the bits and the phase of the electrical modulation signal generating the bits do not align each of the bits in the desired bit order.

FIG. 4 illustrates a schematic diagram of a bit interleaved OTDM transmitter of the present invention that uses optical multiplexing to multiplex four channels of data where the phase of the electrical modulation signal generating the bits is adjusted to align each of the bits in the desired bit order.

FIG. 5 illustrates a schematic diagram of a packet interleaved OTDM transmitter of the present invention that uses optical packet multiplexing to multiplex N channels of packet data.

FIG. 6 illustrates a schematic diagram of an OTDM transmitter of the present invention that includes channel marking and feedback for synchronizing the electrical modulation signal to the optical clock signal.

FIG. 7 illustrates a schematic diagram of another embodiment of an OTDM transmitter of the present invention that includes channel marking and feedback for synchronizing the electrical modulation signal to the optical clock signal.

FIG. 8 illustrates a schematic diagram of an OTDM transmitter of the present invention that uses optical multiplexing with at least one variable optical delay to multiplex N channels of data.

FIG. 9 illustrates a schematic block diagram of a polarization division multiplexer according to the present invention that generates a polarization multiplexed optical signal.

FIG. 10 illustrates a schematic block diagram of one embodiment of a polarization division multiplexer according to the present invention that generates a polarization multiplexed optical signal.

### DETAILED DESCRIPTION

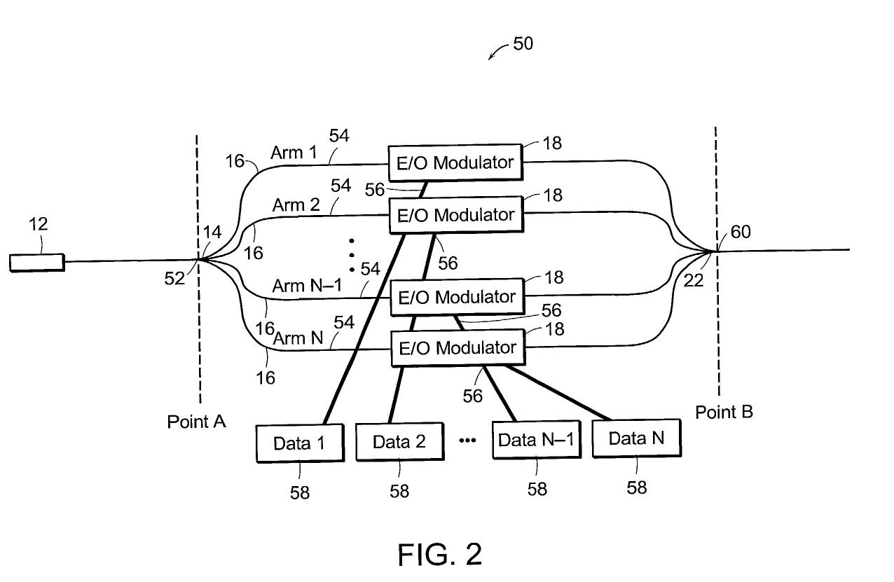

Referring more particularly to the figures, like numerals indicate like structural elements and features in various figures. FIG. 2 illustrates a schematic diagram of a bit interleaved OTDM transmitter 50 of the present invention that uses optical multiplexing to multiplex N channels of data that are modulated with electrical modulation signals that are unsynchronized relative to each other. The OTDM transmitter 50 includes a pulsed laser 12 that generates an optical clock signal. The laser 12 can generate any type of optical clock signal, such as a periodic pulse train or a sinusoidally modulated optical clock signal. In one embodiment, the laser 12 generates a periodic pulse train having a repetition rate that is equal to the single-channel bit rate R. Each pulse in the pulse train has a pulse width Tₚ that is less than (NR)⁻¹ to ensure that each pulse can be positioned in its allocated time slot.

In one embodiment, every other pulse in the pulse train is orthogonally polarized. Orthogonally polarizing every other pulse will reduce pulse-to-pulse interference caused by coherence effects. Consequently, orthogonally polarizing every other pulse will facilitate higher speed transmission and transmission over longer distances with reduced sensitivity to linear and non-linear impairments such as chromatic dispersion, polarization mode dispersion, temperature dependent dispersion, timing jitter and numerous other impairments. In addition, orthogonally polarizing every other pulse will result in a greater tolerance for broader pulses and pulses with pedestals.

The OTDM transmitter 50 includes an optical splitter 14 that receives the optical clock signal at an input 52 and splits the optical clock signal into a plurality of channels or arms 16, where each arm comprises an optical waveguide 54. In FIG. 2, the plurality of arms 16 is represented as N arms, where N can be any number. The splitter 14 can be any type of optical splitter. In one embodiment, the splitter 14 comprises a 1XN fused fiber coupler. In another embodiment, the splitter 14 comprises an integrated optical waveguide splitter. In yet another embodiment, the optical clock signal is polarized and the splitter 14 comprises polarization selective components.

The OTDM transmitter 50 also includes a plurality of optical modulators 18. The term optical modulator is defined herein to mean any type of optical data generator or optical data encoder. The modulators 18 may modulate amplitude or phase or both amplitude and phase. Any type of optical modulator can be used in the present invention, such as an electro-optical modulator or an electro-absorption modulator.

In one embodiment, the optical modulators 18 are electro-optic modulators. A respective one of the plurality of electro-optic modulators 18 is optically coupled to a respective one of the plurality of arms 16. Each of the plurality of electro-optic modulators 18 includes an electrical modulation signal input 56 that accepts an electrical modulation signal. A respective one of the plurality of electro-optic modulators 18 modulates the optical clock signal propagating in a respective one of the N arms 16 with an electrical modulation signal. The modulator 18 may be any kind of electro-optical modulator, such as a Mach-Zehnder interferometric modulator, electro-absorption modulator, liquid crystal, or a polymer modulator.

In one embodiment, the modulator 18 is a Mach-Zehnder interferometric lithium niobate modulator. The operation of Mach-Zehnder interferometric lithium niobate modulators is well known. The refractive index of the lithium niobate electro-optic material changes with the application of an external modulation voltage. When no external modulation voltage is applied, the refractive index of the lithium niobate in both arms of the interferometer is substantially the same. If the path length difference between the two arms of the interferometer is π, the optical fields in the two arms of interferometer destructively interfere and consequently no light is transmitted through the modulator. Thus, when no external modulation voltage is applied, the Mach-Zehnder interferometer generates a “0” bit.

If an external modulation voltage is applied to the modulator, an additional phase shift is introduced in one of the arms of the interferometer. A voltage-induced refractive index change in one of the arms causes constructive interference and the modulator produces light. Thus, when an external modulation voltage is applied, the Mach-Zehnder interferometer generates a “1” bit. Therefore, each of the modulators 18 generates an optical bit stream that is an optical replica of the electrical modulation signal applied to the modulator.

The OTDM transmitter 50 includes one or more electrical modulation sources 58 that are electrically connected to the electrical modulation signal input of at least one of the plurality of modulators. In one embodiment, an independent electrical modulation source is electrically connected to the electrical modulation signal input of each of the plurality of modulators. In this embodiment, the phase of each of the electrical modulation signals is not synchronized with the phase of each of the other electrical modulation signals. In one embodiment, the electrical modulation signal applied to each of the modulators 18 has a relative phase that aligns each of the optical bit streams in the desired bit order. By desired bit order we mean the relative position of one bit to another bit.

The OTDM transmitter 50 includes an optical combiner 22 that has a plurality of optical inputs and an optical output 60. The optical combiner 22 may be any type of optical combiner. For example, the optical combiner 22 may be a 1XN fused fiber coupler, an integrated waveguide combiner, or a polarization-type combiner. A respective one of the plurality of optical inputs of the optical combiner 22 is optically coupled to a respective one of the optical outputs of the plurality of electro-optic modulators 18. The optical combiner 22 assembles or combines each of the independently modulated optical bit streams into a single bit interleaved optical bit stream at the optical output 60. In one embodiment, the bit interleaved optical bit stream contains bits with well-defined relative polarization. In another embodiment, the bit interleaved optical bit stream contains bits with random polarizations.

In the OTDM transmitter of FIG. 2, the position of each bit in the bit interleaved optical bit stream is determined by both the optical path length propagating the bit and by the relative phase of the modulation signal that generated the bit. The optical path length determines the relative position of the bits in the bit stream. The relative phase of the modulation signal determines the relative order of the bits in the bit stream. Thus, each bit can be positioned in its desired time slot by properly selecting both the optical path length propagated by the bit and the relative phase of the modulation signal that generated the bit.

This feature is achieved by using electrical modulation signals that are unsynchronized relative to each other. By unsynchronized, we mean that the phase of each of the electrical modulation signals can be independently adjusted relative to the phase of each of the other electrical modulation signals to position the bits in the desired order. Also, the phase of the electrical modulation signal can be changed to insure that the optical signal is correctly aligned or synchronized in time with the electrical modulation signal.

Each of the plurality of arms 16 has an optical path length that begins at an input 52 to the splitter 14 and ends at the optical output 60 of the combiner 22. Alternatively, the optical path length of each of the plurality of arms 16 can be measured from other locations. For example, the optical path length can be measured from the input 56 of the modulator 18 to the optical output 60 of the combiner 22. In one embodiment, the optical path length of each of the N arms of the plurality of arms 16 differs from each of the other optical path lengths of the plurality of arms 16 by a differential optical path length LD that is equal to c/(nNR), where c is the speed of light, n is the refractive index of the optical fiber or optical waveguide, N is the number of the arm, and R is the bit rate. In other embodiments, the optical path length of each of the N arms of the plurality of arms 16 differs from each of the other optical path lengths of the plurality of arms 16 by an integer multiple of the differential optical path length LD.

One advantage of the OTDM transmitter of the present invention is that it is relatively easy to construct compared with known OTDM transmitters, especially for transmitters operating at high data rates. The required differential optical path length LD decreases as the bit rate increases. Consequently, it becomes increasingly difficult, as the bit rate increases, to fabricate planar lightwave circuit multiplexer where the optical path length of each of the plurality of arms 16 differs from each of the other optical path lengths by one differential optical path length L_{D}.

In the OTDM transmitter of the present invention, the optical path lengths can differ by more than the differential optical path length L_{D} and still have each bit aligned in the desired time slot T_{R}=(NR)⁻¹. The optical path lengths may be any integer multiple of L_{D}, and the phase of each of the electrical modulation signals is adjusted to align the bits in the desired bit order. It is much easier to construct an OTDM transmitter where each of the optical path lengths of the plurality of arms differs by several differential optical path lengths L_{D}.

At ultra-fast data rates, L_{D} becomes very small and it is necessary, in some embodiments of the OTDM transmitter, to use arms that have optical path lengths that differ by several differential optical path lengths L_{D}. For example, if the OTDM transmitter is an integrated optic device, it is physically difficult to construct the OTDM transmitter with very small differential optical path lengths L_{D}. Furthermore, if the laser 12 has a high degree of coherence, it is desirable for the optical path lengths of the plurality of arms to differ by many differential optical path lengths L_{D} in order to reduce pulse-to-pulse interference caused by coherence effects. Pulse-to-pulse interferences can be further reduced by orthogonally polarizing every other bit in the bit interleaved bit stream.

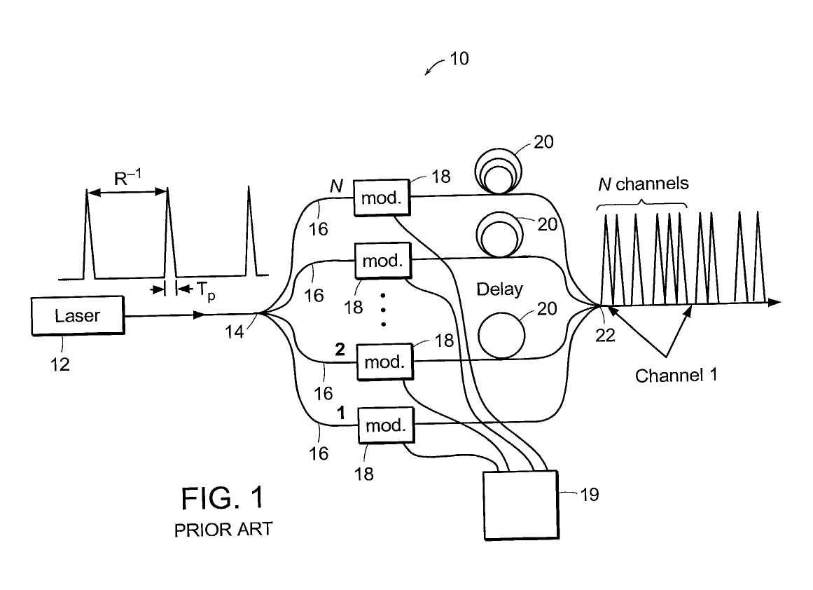

Another advantage of the OTDM transmitter of the present invention is that, unlike the prior art OTDM transmitter described in connection with FIG. 1, the optical clock signals are not required to simultaneously arrive at the input of the modulator 18. Instead, with the OTDM transmitter of the present invention, the differential optical path length L_{D} can be realized at any point in the optical path.

The present invention features a method of generating a bit interleaved optical time division multiplex signal using the OTDM transmitter of FIG. 2. The method includes splitting an optical clock signal into a plurality of channels or arms. Each of the plurality of arms has an optical path length. The clock signal is modulated in each of the plurality of arms with an unsynchronized electrical modulation signal, thereby generating an independently modulated optical bit stream in each arm. The modulated optical bit stream is combined in each arm into a bit interleaved optical bit stream.

Each bit in the bit interleaved optical bit stream is positioned in a time slot that is determined by an optical path length of the arm propagating the bit and a phase of the electrical modulation signal that generated the bit. In one embodiment, the phase of a respective one of the electrical modulation signals is adjusted to change the relative order of bits generated by a respective one of the plurality of arms.

In one embodiment, the OTDM transmitter 50 of FIG. 2 is configured as a multi-rate transmitter or a channel-dropping transmitter. Channels are added by activating the channel's electrical modulation sources 58. Channels are dropped by applying a switching signal to the channel's electrical modulation source 58. If the modulation signal is dropped on selected modulators 18, the rate will be reduced. For example, if the modulation signal is dropped on every other modulator, the bit rate of the will be decreased by a factor of two.

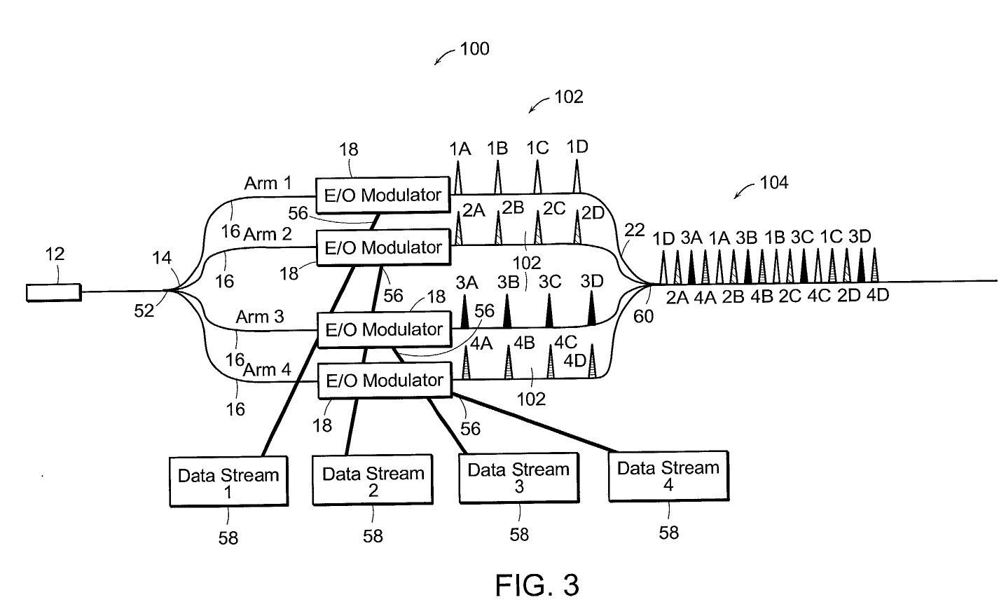

FIG. 3 illustrates a schematic diagram of a bit interleaved OTDM transmitter 100 of the present invention that uses optical multiplexing to optically multiplex four channels of data where the optical path propagating the bits and the phase of the electrical modulation signal generating the bits do not align each of the bits in the desired bit order. The OTDM transmitter 100 of FIG. 3 is identical to the OTDM transmitter 50 of FIG. 2 with N equal to four.

Each of the four modulators 18 is modulated by a separate and independent electrical modulation source 58 and generates a modulated optical bit stream 102. Four bits of the modulated optical bit stream 102 are illustrated in FIG. 3 as NA through ND, where N is the number of the arm (i.e. one through four) and the letters A through D designate the four bits. The optical combiner 22 assembles or combines each of the independently modulated optical bit streams into a single bit interleaved optical bit stream 104.

The bits in the bit interleaved optical bit stream generated by the first arm 16 are not positioned in the desired bit order because the relative phase of the electrical modulation signal generating the bits has misaligned the optical bit stream. In the example illustrated in FIG. 3, the relative phase of the electrical modulation signal is misaligned by four bit periods of the bit interleaved optical bit stream 104.

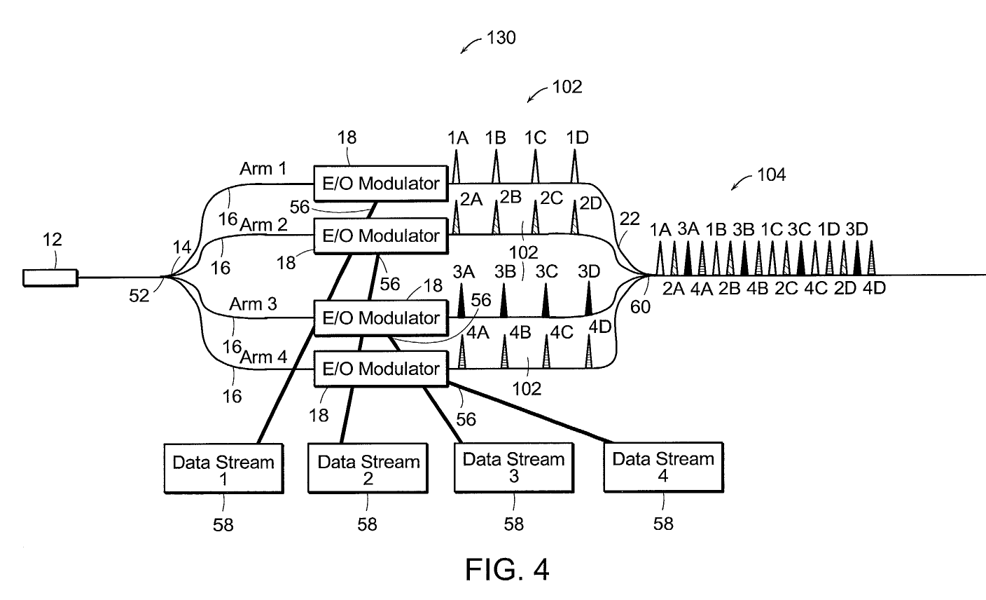

FIG. 4 illustrates a schematic diagram of a bit interleaved OTDM transmitter 130 of the present invention that uses optical multiplexing to multiplex four channels of data where the phase of the electrical modulation signal generating the bits is adjusted to align each of the bits in the desired bit order. The OTDM transmitter 130 of FIG. 4 is identical to the OTDM transmitter 100 of FIG. 3, except that the phase of the electrical modulation signal in the first arm 106 is adjusted to align each bit in the desired order.

As described in connection with FIG. 3, each of the four modulators 18 is modulated by a separate and independent electrical modulation source 58 and generates a modulated optical bit stream 102. Four bits of the modulated optical bit stream 102 are illustrated in FIG. 4 as NA through ND, where N is the number of the arm (i.e. one through four) and the letters A through D designate the four bits. The optical combiner 22 assembles or combines each of the independently modulated optical bit streams into a single bit interleaved optical bit stream 104. Each bit in the bit interleaved optical bit stream 104 is positioned in the desired bit period.

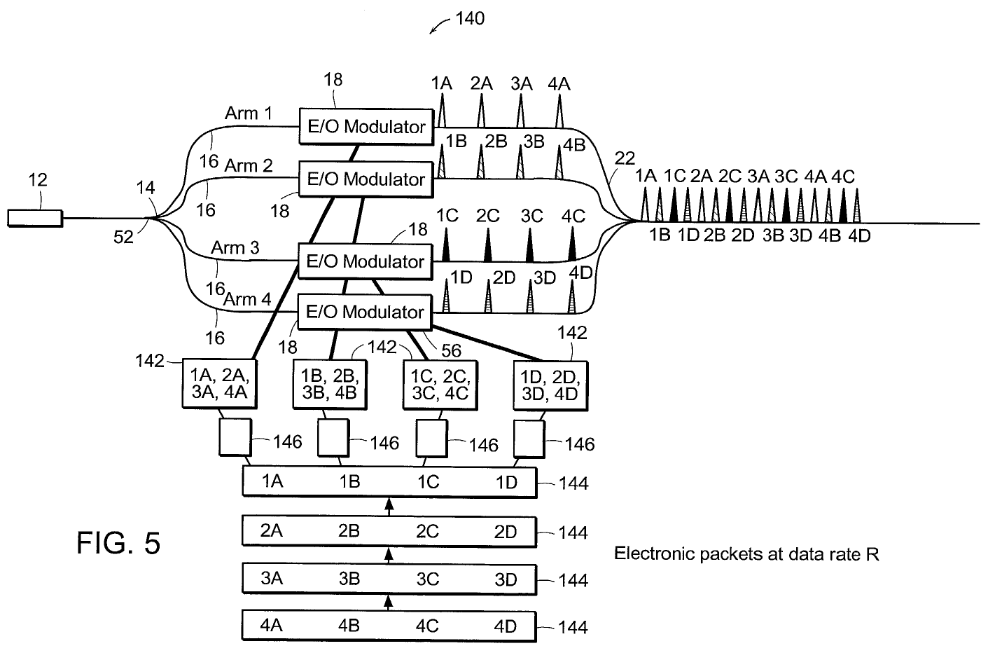

The present invention applies to packet interleaved OTDM transmitters as well as bit interleaved OTDM transmitters. FIG. 5 illustrates a schematic diagram of a packet interleaved OTDM transmitter 140 of the present invention that uses optical packet multiplexing to multiplex N channels of packet data. The OTDM transmitter 140 of FIG. 5 is identical to the OTDM transmitter 50 of FIG. 2, except that the OTDM transmitter 140 uses packet modulation sources 142.

An electrical data packet generator 144 generates the desired data packets. The data packet generator 144 is electrically connected to an input of the packet modulation sources 142. In one embodiment, a buffer 146 is electrically connected between the electrical data packet generator 144 and the packet modulation sources 142 to delay the data driving the packet modulation sources 142. In another embodiment, the packet modulation sources 142 include a buffer that delays the data before modulation.

In operation, an electrical packet drives the packet modulation sources at data rate R. The phase of the packet modulation sources is adjusted so that each bit is assembled at the optical combiner 22 in optical packets at data rate NR that match the electrical packets at data rate R. That is, the packet duration has been compressed and the bits in the packet are rate converted to a data rate equal to NR.

The packet interleaved OTDM transmitter 140 has many advantages over prior art packet interleaved OTDM transmitters that use compression stages. One advantage is that the OTDM transmitter 140 is simpler and easier to integrate. Prior art compression stages for OTDM transmitters have many components such as couplers, semiconductor optical amplifiers configured as on-off switches, and delay lines. Another advantage is that the OTDM transmitter 140 can be constructed with optical path lengths that differ by more than the differential optical path length L_{D} and still have the bit assembled in the desired data packet. As described above, the optical path lengths may be any integer multiple of L_{D}, and the phase of each of the electrical modulation signals is adjusted to align the bits in the desired bit order, thereby forming the data packets.

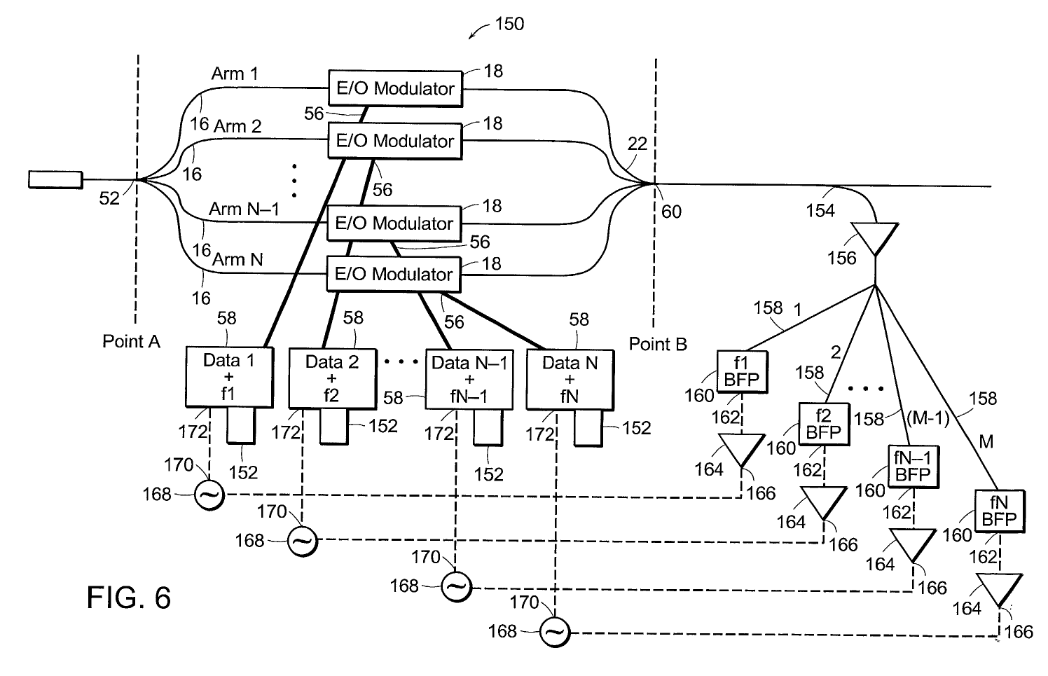

FIG. 6 illustrates a schematic diagram of an OTDM transmitter 150 of the present invention that includes channel marking and feedback for synchronizing the electrical modulation signal to the optical clock signal. The OTDM transmitter 150 is similar to the OTDM transmitter 50 of FIG. 2. The OTDM transmitter 150 uses optical multiplexing to multiplex N channels of data being modulated with electrical modulation signals that are unsynchronized relative to each other. The OTDM transmitter 150 further includes a dither signal generator 152 that superimposes a dither signal onto at least one of the electrical modulation signals.

The OTDM transmitter 150 includes a laser 12 that generates an optical clock signal comprising a periodic pulse train having a repetition rate equal to the single-channel bit rate R. Each pulse in the pulse train has a pulse width Tₚ that is less than (NR)⁻¹ to ensure that each pulse can be positioned in its allocated time slot. The OTDM transmitter 150 also includes an optical splitter 14 that receives the optical clock signal at an input 52 and splits the optical clock signal into a plurality of channels or arms 16, where each arm 16 comprises an optical waveguide 54.

The OTDM transmitter 150 also includes a plurality of electro-optic modulators 18. A respective one of the plurality of electro-optic modulators 18 is optically coupled to a respective one of the plurality of arms 16. Each of the plurality of electro-optic modulators 18 includes an electrical modulation signal input 56 that accepts an electrical modulation signal. A respective one of the plurality of electro-optic modulators 18 modulates the optical clock signal propagating in a respective one of the N arms 16 with an electrical modulation signal.

The OTDM transmitter 150 includes one or more electrical modulation sources 58 that are electrically connected to the electrical modulation signal input of at least one of the plurality of modulators 18. In one embodiment, an independent electrical modulation source is electrically connected to the electrical modulation signal input of each of the plurality of modulators so that the relative phase of each of the electrical modulation signals is not synchronized with the relative phase of each of the other electrical modulation signals, as described in connection with FIG. 2.

A dither signal generator 152 is electrically coupled to an electrical modulation signal input of at least one of the plurality of modulators 18. In one embodiment, the electrical modulation signal generator 58 includes the dither signal generator 152. The dither signal generator 152 generates a dither or a sub-carrier modulation signal, which is a relatively low frequency and low amplitude signal compared with the modulated data stream. The dither signal is superimposed onto the electrical modulation signal, thereby superimposing a dither signal onto the modulated optical clock signals. Therefore, at least one of the plurality of modulators 18 generates a modulated optical clock signal that includes dithered optical signals. In one embodiment, the dither frequencies are substantially in the range of 1 KHz to 10 MHz. In one embodiment, the dither signal is a unique dither signal that identifies the arm from which the bit stream propagated.

The OTDM transmitter 150 includes an optical combiner 22 that has a plurality of optical inputs and an optical output 60. A respective one of the plurality of optical inputs of the optical combiner 22 is optically coupled to a respective one of the optical outputs of the plurality of electro-optic modulators 18. The optical combiner 22 assembles or combines each of the independently modulated optical bit streams into a single bit interleaved optical bit stream at the optical output 60.

The single bit interleaved optical bit stream is monitored by an electro-optic feedback loop that includes an optical coupler, a detector, a plurality of electronic bandpass filters, and a plurality of electrically variable phase delay generators. An optical coupler 154 is coupled to the optical output 60 of the transmitter 150 and directs a portion of the single bit interleaved optical bit stream to an electronic detector 156. The electronic detector 156 detects the bit interleaved optical bit stream that includes the dithered optical signals. The detector can be any detector. The detector 156 has M electrical outputs 158. In one embodiment, the number of electrical outputs 158 corresponds to the number channels that are marked and monitored. Any number of channels can be marked and monitored according to various embodiments of the invention.

Each output 158 of the detector 156 is electrically coupled to one of M bandpass electrical filters 160. Each of the bandpass filters 160 has a bandwidth that passes at least one dither signal and rejects other dither signals. In one embodiment, the bandwidth of each bandpass filter 160 passes one of the dither signals and rejects all of the other dither signals. The amplifiers 164 may be electrically coupled to the output 162 of one or more of the bandpass filters 160 to increase the signal level of dither signals passed by the bandpass filters 160. The amplifier can be any amplifier.

An electronically variable phase delay generator 168, such as a voltage-controlled oscillator or a phase shifter, is electrically coupled to the output 166 of each of the amplifiers 164. An output 170 of a respective phase delay generator 168 is coupled to a drive input 172 of a respective one of the electrical modulation sources 58. That is, the dither signal passed by a respective one of the bandpass filters is feedback to the phase delay generator that generates a signal that controls a respective one of the electrical modulation sources 58. An electronic amplifier or other signal conditioning electronics (not shown) may be electrically coupled between the output 170 of the phase delay generators 168 and the input 172 of the electrical modulation sources 58.

In operation, a respective one of the phase delay generators 168 generates a signal that has a frequency that is proportional to the intensity of a respective one of the detected dither signal. The signal generated by a respective one of the phase delay generators 168 drives a respective one of the electrical modulation sources 58. As the intensity of a respective one of the detected dither signals increases, the frequency of the signals generated by a respective one of the phase delay generators 168 changes, thereby changing the phase of the electrical modulation signal of a respective one of the electrical modulation sources.

In one embodiment, a unique dither signal is superimposed on the electrical modulation signal in at least one arm 16 in order to identify or mark at least one of the channels in an OTDM communication system. Accordingly, the present invention features a method of marking and identifying channels in an OTDM communication system. The method of marking and identifying channels in an OTDM communication system includes splitting an optical clock signal into a plurality of arms. The optical clock signals are modulated in at least one of the plurality of arms with both an electrical modulation signal and a dither signal, thereby generating a modulated optical bit stream comprising dithered optical signals. The modulated optical bit streams are combined in each arm into a bit interleaved optical bit stream. The dithered optical signals are detected, thereby identifying the channel.

In another embodiment, a dither signal is superimposed on the electrical modulation signal in at least one arm 16 in order to synchronize the optical clock signal to the electrical modulation signal at the modulator 18. The electrical modulation signal in at least one arm 16 can be synchronize to the optical clock signal in order to synchronize the optical clock signal to the center of the electronic switching window. The electrical modulation signal in at least one arm 16 can also be synchronize to the optical clock signal in order to perform RZ/NRZ alignment stabilization. Accordingly, the present invention features a method of synchronizing an electrical modulation signal to an optical clock signal in an OTDM transmitter. The method of synchronizing includes splitting an optical clock signal into a plurality of arms. The optical clock signals are modulated in at least one of the plurality of arms with both an electrical modulation signal and a dither signal, thereby generating a modulated optical bit stream comprising dithered optical signals. The modulated optical bit streams are combined in each arm into a bit interleaved optical bit stream. The dithered optical signals are detected. A phase of the electrical modulation signal is adjusted in response to the detected dithered optical signals to position the bits in the bit interleaved optical bit stream in a desired relative order. In one embodiment, a frequency of a voltage-controlled oscillator is changed in response to the detected dither signals and the phase of the electrical modulation signal is adjusted in response to the frequency change.

In another embodiment of the OTDM transmitter 150, the dither generator 152 is not used. Instead, the optical signals are monitored for electrical signals that are indicative of the electrical modulation signals. In one embodiment, the RF spectrum of the optical signals is monitored for signals indicative of the electrical modulation signals. These signals can be used for channel marking and feedback for synchronizing the electrical modulation signal to the optical clock signal.

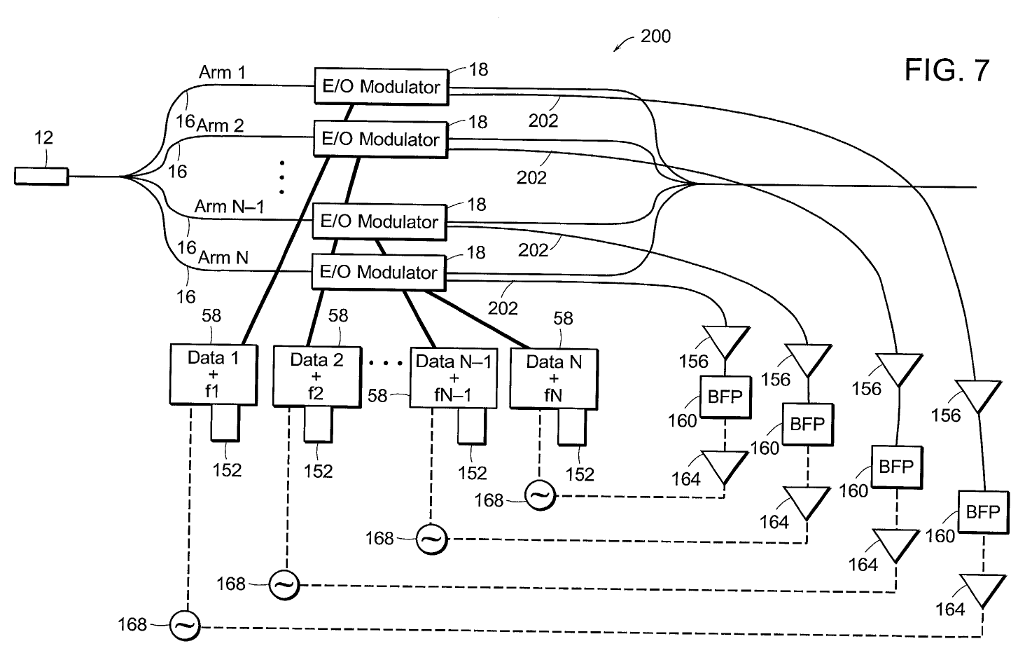

FIG. 7 illustrates a schematic diagram of another embodiment of an OTDM transmitter 200 of the present invention that includes channel marking and feedback for synchronizing the electrical modulation signal to the optical clock signal. The OTDM transmitter 200 is similar to the OTDM transmitter 150 of FIG. 6. However, instead of monitoring the resulting single bit interleaved optical bit stream, a complementary or second port 202 of at least one of the modulator 18 is monitored.

In one embodiment, the modulator 18 comprises a 1×2 Mach-Zehnder interferometric modulator. This type of modulator has two output ports. The operation of such modulators is well known. The second port passes the out-of-phase light scattered in the modulator. When a modulation voltage equal to Vπ is applied to the modulator, optical signals propagate through only one port. Otherwise the optical signals propagate through both the first and the second ports. Therefore a portion of the modulated optical signal can be monitored from the second port 202 of the modulator 18.

The second port 202 of the modulator 18 is monitored by an electro-optic feedback loop as described in connection with FIG. 6. In one embodiment, the feedback loop includes a detector, a plurality of electronic bandpass filters, and a plurality of voltage-controlled oscillators.

The operation of the OTDM transmitter 200 is similar to the operation of the OTDM transmitter 150 of FIG. 6. In one embodiment, the electro-optic feedback loop is used to synchronize the optical clock signal to the electrical modulation signal at the modulator 18. A respective one of the phase delay generators 168 generates a signal that has a frequency that is proportional to the intensity of a respective one of the detected dither signal. The signals generated by a respective one of the phase delay generators 168 drives a respective one of the electrical modulation sources 58. As the intensity of the detected dither signals increases, the frequency of the signals generated by a respective one of the phase delay generators 168 changes, thereby changing the phase of the electrical modulation signal of a respective one of the electrical modulation sources and thus changing the order of the bits.

In another embodiment of the OTDM transmitter 200, the dither generator 152 is not used. Instead, the optical signals are monitored for electrical signals that are indicative of the electrical modulation signals. In one embodiment, the RF spectrum of the optical signals is monitored for signals indicative of the electrical modulation signals. These signals can be used for channel marking and feedback for synchronizing the electrical modulation signal to the optical clock signal.

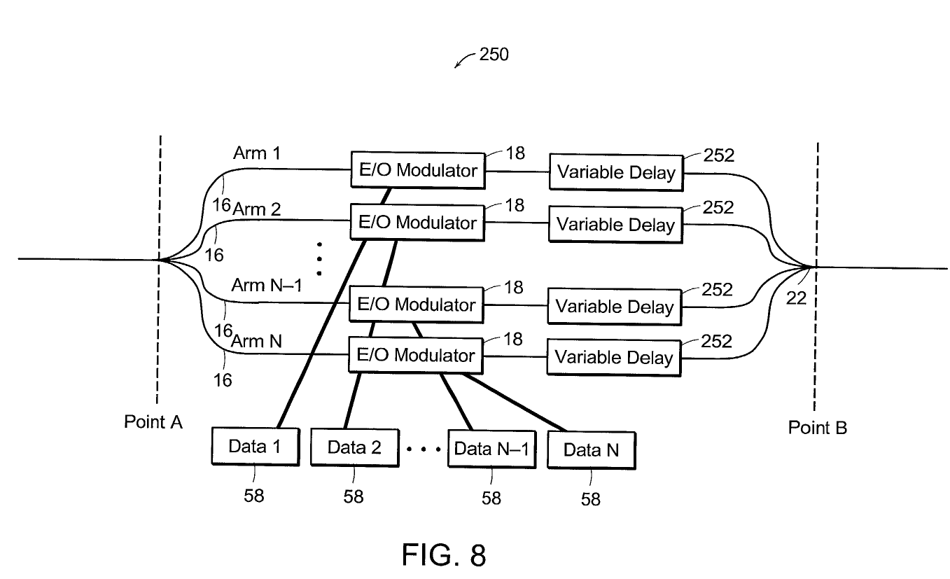

FIG. 8 illustrates a schematic diagram of an OTDM transmitter 250 of the present invention that uses optical multiplexing with at least one variable optical delay 252 to multiplex N channels of data. The OTDM transmitter 250 is similar to the OTDM transmitter 50 of FIG. 2. In addition, the OTDM transmitter 250 includes a variable optical delay 252 that is optically coupled into at least one arm 16 between the electro-optic modulator 18 and the optical combiner 22. In other embodiments, the variable optical delay 252 can be optically coupled at any point in the at least one arm 16.

The variable optical delay 252 can be any variable optical delay. For example, the variable optical delay 252 can be constructed from bulk optics and at least one tunable delay stage. In addition, the variable optical delay 252 can be constructed from at least one fiber stretcher, phase modulator, or variable path router. Although the OTDM transmitter 252 of FIG. 5 is illustrated with a variable optical delay 252 positioned in each arm 16, the OTDM transmitter 250 may include a variable optical delay 252 in any number of the arms 16.

The variable optical delay 252 adjusts the relative position of each bit in the bit stream. In one embodiment, the variable optical delay 252 continuously adjusts the relative position of the bits in the bit stream. In one embodiment, the electrical modulation signals are unsynchronized relative to each other, as described in connection with FIG. 2. In this embodiment, the relative phase of the electrical modulation signal can be adjusted to change the relative order of each bit in the bit stream.

One advantage of the OTDM transmitter 250 of FIG. 8 is that the optical path lengths of each of the plurality of arms 16 do not have to be precisely controlled. This is because the optical bit streams can be aligned into their respective time slot T_{R}=(NR)⁻¹ by adjusting the variable optical delays 252. The OTDM transmitter 250 can be configured as a bit interchanger.

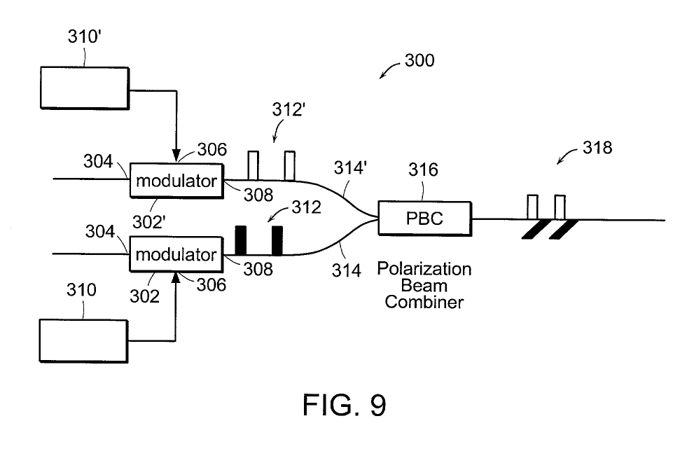

FIG. 9 illustrates a schematic block diagram of a polarization division multiplexer 300 according to the present invention that generates a polarization multiplexed optical signal. Polarization multiplexed optical signals include multiple channels that have different polarization states. That is, the pulse train comprises bits that have different polarizations. There are numerous types of polarization multiplexing. One type of polarization multiplexing is orthogonal linear polarization multiplexing. Another type is orthogonal circular polarization multiplexing. The different polarizations may overlap in time. Also, the different polarizations may be bit interleaved or may be substantially periodic.

In one embodiment, the polarization division multiplexer 300 is an OTDM transmitter that generates a polarization division multiplexed (PDM) optical communication signal 318. PDM communication systems have numerous advantages over non-PDM communication systems. There are numerous advantages to PDM communication systems.

One advantage of PDM communication systems is that they have greater spectral efficiency compared with non-PDM systems. This is because data propagates in two orthogonally polarized pulse trains at a single wavelength. Thus, polarization division multiplexing effectively doubles the data capacity compared with non-PDM systems. Another advantage is that PDM communication systems have higher dispersion tolerance as compared with non-PDM systems. The dispersion tolerance of PDM communication systems can be four times greater than comparable non-PDM systems.

The multiplexer 300 includes a first 302 and a second data modulator 302′. Any type of optical modulator can be used, such as an electro-optical, an electro-absorption, liquid crystal, solid-state, or polymer modulator. The modulators 302, 302′ include an optical input 304, an electrical modulation signal input 306, and an optical output 308. The modulators 302, 302′ may modulate amplitude or phase or both amplitude and phase.

The multiplexer 300 also includes a first 310 and a second electrical modulation source 310′. The outputs of the first 310 and the second electrical modulation source 310′ are electrically connected to the electrical modulation signal input 306 of the first 302 and second modulator 302′, respectively. The electrical modulation sources 310, 310′ may be separate and independent modulation sources or may be one modulation source having two outputs. In one embodiment, the first 310 and the second electrical modulation source 310′ are unsynchronized.

Each of the first 310 and the second electrical modulation source 310′ generates a data signal. In one embodiment, the data signals generated by each of the electrical modulation sources 310, 310′ have a relative phase that aligns each bit of the optical pulse trains in the desired bit order as described herein. By desired bit order, we mean the desired position of one bit relative to another bit in a pulse train.

In one embodiment, an optical clock signal is applied to the optical input 304 of each of the modulators 302, 302′. The optical clock signal is modulated by the data signals generated by the first and the second electrical modulation sources 310, 310′ and applied to the electrical modulation signal inputs 306. The first 302 and the second modulator 302′ generate a first 312 and a second 312′ modulated optical pulse train comprising the modulated data. In one embodiment, the modulated optical pulse trains 312, 312′ have the same polarization.

In another embodiment, the first 302 and the second data modulator 302′ are directly modulated lasers. The data signals generated by the first and the second electrical modulation sources 310, 310′ are applied to the first and the second directly modulated lasers, respectively, to generate the first 312 and the second 312′ modulated optical pulse train.

In another embodiment, the modulators 302, 302′ are pulse carving modulators that include a pulse carving section. A CW optical signal is applied to the optical inputs 304 and the pulse carving section generates an optical clock signal. Pulse carving is known in the art and is described, for example, in U.S. Pat. No. 4,505,587, entitled Picosecond Optical Sampling. Using a modulator with a pulse carving section is advantageous because the optical clock signal is derived from the modulation signal and, therefore, the modulation signal is inherently synchronized to the optical clock signal.

The optical output 308 of the first 302 and the second modulator 302′ is optically coupled to a first 314 and a second optical input 314′ of a beam splitter/combiner 316. In one embodiment, the beam splitter/combiner 316 is a polarization beam splitter/combiner 316. Polarization beam combiners are advantageous because they have relatively low loss. Numerous other beam splitter/combiner, such as couplers and polarization maintaining couplers, can be used. In one embodiment, polarization maintaining optical fiber is used to optically couple the outputs 308 of the modulators 302, 302′ to the inputs 314, 314′ of the polarization beam splitter/combiner 316. The polarization beam combiner 316 assembles or combines the modulated optical pulse trains into a single orthogonally polarized bit interleaved pulse train 318. In other embodiments, the polarized bit interleaved pulse train 318 is not orthogonally polarized, but has two different polarizations.

Although the multiplexer of FIG. 9 is described in connection with two modulators, any number of modulators can be used to polarization multiplex any number of pulse trains. In some embodiments, at least one optical beam combiners are used to combine optical outputs from a plurality of modulators and generate two bit interleaved modulated optical pulse trains that are optically coupled to inputs 314, 314′ of the polarization beam splitter/combiner 316, as described herein.

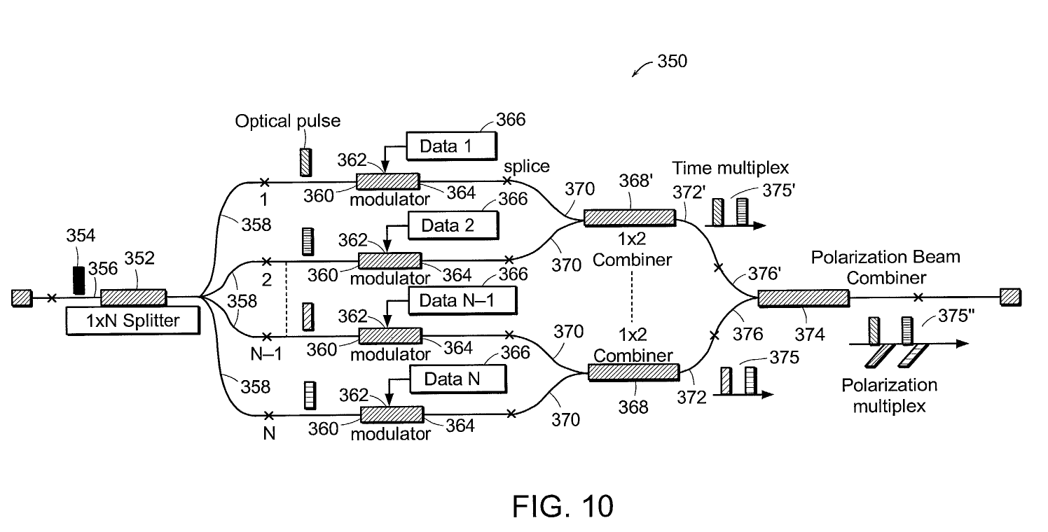

FIG. 10 illustrates a schematic block diagram of one embodiment of a polarization division multiplexer 350 according to the present invention that generates a polarization multiplexed optical signal. In one embodiment, the polarization division multiplexer 350 is an OTDM transmitter that generates a polarization multiplexed optical communication signal. The multiplexer 350 includes an optical splitter 352 that receives an optical clock signal 354 at an input 356 and splits the optical clock signal 354 into a plurality of channels or arms 358, where each arm 358 comprises an optical waveguide.

In one embodiment, the optical waveguides comprising the arms 358 are polarization maintaining optical fibers. The splitter 352 can be any type of optical splitter. In one embodiment, the splitter 352 comprises a 1XN fused fiber coupler, where N is the number of arms. In another embodiment, the splitter 352 comprises an integrated optical waveguide splitter. In another embodiment, the splitter 352 is a polarization maintaining splitter.

The polarization division multiplexer 350 also includes a plurality of modulators 360. Any type of modulator can be used. For example, the modulators 360 may be electro-optic modulators, electro-absorption modulators, liquid crystal modulators, solid-state modulators, or polymer modulators. In one embodiment, the modulators 360 are lithium niobate Mach-Zehnder interferometric electro-optic modulators. A respective one of the plurality of modulators 360 is optically coupled to a respective one of the plurality of arms 358. In one embodiment, polarization maintaining optical fiber is used to optically couple each of the plurality of modulators 360 to one of the plurality of arms 358.

Each of the plurality of modulators 360 includes an electrical modulation signal input 362 that receives an electrical modulation signal. A respective one of the plurality of modulators 360 modulates the optical clock signal 354 propagating in a respective one of the plurality of arms 358 with an electrical modulation signal and generates a modulated optical signal at an optical output 364.

In other embodiments, each of the plurality of modulators 360 includes a pulse carving section, as described in connection with FIG. 9. A CW optical signal is applied to the optical splitter 352 and is split into the plurality of arms 358. Using a modulator with a pulse carving section is advantageous because the optical clock signal is derived from the modulation signal and, therefore, the modulation signal is inherently synchronized to the optical clock signal.

The polarization division multiplexer 350 also includes a plurality of electrical modulation sources 366. A respective one of the plurality of electrical modulation sources 366 is electrically connected to the electrical modulation signal input 362 of a respective one of the plurality of modulators 360. The electrical modulation sources 366 may be separate and independent modulation sources or may be one or more modulation sources having multiple outputs. In one embodiment, at least two of the electrical modulation sources 366 are unsynchronized relative to the other electrical modulation sources.

Each of the plurality of electrical modulation sources 366 generates a data signal. In one embodiment, the data signals generated by each of the electrical modulation sources have a relative phase that aligns each bit of the optical pulse trains in the desired bit order. By desired bit order, we mean the desired position of one bit relative to another bit in a pulse train.

Polarization division multiplexers having more than two arms 358 include at least one optical combiners. The optical combiners combine the optical pulse trains propagating in each of the plurality of arms 358 into two bit (or time) interleaved pulse trains. In one embodiment, the multiplexer 350 includes a first 368 and a second optical combiner 368′ and each of the first 368 and second optical combiner 368′ has N/2 inputs, where N is the number of arms 358.

In other embodiments, the multiplexer 350 includes cascaded combinations of low-order optical combiners, such as 1×2 or 1×4 optical combiners, that are configured to produce two bit (or time) interleaved pulse trains. Each of the optical combiners has a plurality of optical inputs 370 and an optical output 372. The combiners may be constructed from polarization maintaining optical fiber.

A respective one of the plurality of optical inputs 370 of each of the two optical combiners 368, 368′ is optically coupled to an optical output 364 of a respective one of the plurality of modulators 360. In one embodiment, polarization maintaining optical fiber is used to couple the optical outputs 364 of the modulators 360 to the optical inputs 370 of the optical combiner 368, 368′. The optical combiners 368, 368′ assemble or combine the independently modulated optical pulse trains propagating in each of the plurality of arms 358 into a first 375 and a second bit interleaved pulse train 375′. In one embodiment, the independently modulated optical pulse trains have the same polarization.

The multiplexer 350 also includes a polarization beam combiner 374 that has a first 376 and a second optical input 376′ that are optically coupled to the first 372 and the second optical output 372′ of the first 368 and the second optical combiner 368′, respectively. In one embodiment, polarization maintaining optical fiber is used to couple the optical outputs 372, 372′ of the optical combiners 368, 368′ to the optical inputs 376, 376′ of the polarization beam combiner 374.

The polarization beam splitter/combiner 374 assembles or combines the first 375 and the second bit interleaved pulse train 375′ into a single polarization multiplexed optical pulse train 375″ having two polarization states. In one embodiment, every other bit in the polarization multiplexed optical pulse train 375″ has the same polarization. In one embodiment, the two polarization states are orthogonal. The two polarization states may be aligned for maximum transmission through the beam combiner 374. The absolute polarization of the two polarization states may be known or unknown at the output of the polarization beam combiner 374.

The position of each bit in the polarization multiplexed bit interleaved optical pulse train 375″ is determined by both the optical path length propagating the bit and by the relative phase of the modulation signal that generated the bit as described herein. The optical path length determines the relative position of the bits in the pulse train. The relative phase of the modulation signal determines the relative order of the bits in the pulse train. The phase of each of the electrical modulation signals is adjusted to position the bits in the desired order with the desired polarization state. In one embodiment, the phase of each of the electrical modulation signals is adjusted so that every other bit in the polarization multiplexed bit interleaved pulse train has the same polarization state. That is, the bits in the pulse train alternate from the first polarization to the second polarization.

In another embodiment, an integrated optical combiner and polarization beam combiner are coupled directly to the plurality of modulators 360. This integrated device includes the functions of the optical combiner and the polarization beam combiner described above. A respective one of a plurality of optical inputs of the integrated device is optically coupled to the optical output 364 of a respective one of the plurality of modulators 360. Polarization maintaining optical fiber may be used to couple the optical outputs 364 of the plurality of modulators 360 to the optical inputs of the integrated device. The integrated device combines the optical pulse trains propagating in each of the plurality of arms 358 into two bit or time interleaved pulse trains and assembles or combines the first 375 and the second bit interleaved pulse train 375′ into a single polarization multiplexed optical pulse train 375″ having two polarization states.

The multiplexer 350 of the present invention has numerous advantages. One advantage of the multiplexer 350 is that it has relatively high spectral efficiency because data propagates in two polarization states at a single wavelength. Thus, the multiplexer 350 is particularly useful for generating high-speed OTDM signals. Other advantages of the multiplexer 350 are that the dispersion tolerance is significantly increased and timing jitter is significantly reduced because every other bit in the bit interleaved pulse train is a different polarization state.

The bit interleaved OTDM transmitter, packet interleaved OTDM transmitter, and polarization division multiplexer described herein can be constructed in many ways. These devices can be constructed with lightwave circuits. These devices can also be constructed with discrete components that are coupled by optical fibers having precise absolute or differential lengths. New techniques allow optical fibers to be cut to the ultra-precise absolute and differential lengths that are required for constructing these devices for high-speed multiplexing.

One technique to cut optical fibers to ultra-precise lengths is described in U.S. patent application Ser. No. 09/606,706, entitled Method and Apparatus for Cutting Waveguides to Precise Differential Lengths Using Time-Domain Reflectometry, which is assigned to the present assignee. The entire disclosure of U.S. patent application Ser. No. 09/606,706 is incorporated herein by reference.

With this technique, two or more optical waveguides can be cut to a differential accuracy of less than 20 microns by aligning a cleaving tool at a position that is determined with reference to two optical time-domain reflectometry (OTDR) measurements. For example, one OTDR measurement may be taken to an end of the waveguide and the other OTDR measurement may be taken to a reference mirror positioned in the path of radiation propagating from the end of the waveguide.

Equivalents

While the invention has been particularly shown and described with reference to specific preferred embodiments, it should be understood by those skilled in the art that various changes in form and detail may be made therein without departing from the spirit and scope of the invention as defined by the appended claims. For example, the multiplexers and transmitters of the present invention can have any number of channels and any number of the channels can be marked or synchronized. In addition, the multiplexers and transmitters of the present invention can use any type of interleaved data format including packet interleaved data formats. Furthermore, the invention can be practiced in any type of communication system including hybrid optical time-division multiplexing/wavelength-division multiplexing communication systems.

What is claimed is:

1. A polarization division multiplexer comprising:
a. a first and a second modulator, the first and the second modulator receiving an optical signal at an optical input and modulating a first and a second electrical modulation signal that is applied to an electrical modulation input of the first and the second modulator, respectively, the first and the second modulator generating a first and a second modulated optical pulse train at an output of the first and second modulator, respectively; and
b. an optical beam combiner having a first and a second optical input and an optical output, a respective one of the first and the second optical inputs being optically coupled to an optical output of a respective one of the first and the second modulators, the optical beam combiner combining the modulated optical bit stream generated by each of the plurality of modulators into a polarization multiplexed optical pulse train,
wherein a relative position of each pulse in the polarization multiplexed optical pulse train is determined by an optical path length propagated by the pulse and a relative order of each pulse in the polarization multiplexed optical pulse train is determined by a relative phase of the modulation signal that generated the pulse.

2. The multiplexer of claim 1 further comprising a first and a second electrical modulation source, a respective one of the first and the second electrical modulation sources having an output that is electrically coupled to an electrical modulation signal input of a respective one of the the first and the second modulators.

3. The multiplexer of claim 2 wherein one of the first and the second electrical modulation sources generates a modulation signal with a phase that is independent of the phase of modulation signal generated by the other electrical modulation source.

4. The multiplexer of claim 1 further comprising an optical splitter having an optical input that receives an optical signal and having a first and a second output that produce the optical signal, a respective one of the first and the second outputs being optically coupled to an optical input of a respective one of the first and the second modulators.

5. The multiplexer of claim 4 wherein the optical splitter maintains the polarization state of the optical signal.

6. The multiplexer of claim 1 wherein the first and the second inputs of the optical beam combiner are optically coupled to the optical outputs of the first and the second modulators, respectively, with polarization maintaining optical fiber.

7. The multiplexer of claim 1 further comprising a polarization controller that is optically coupled to the output of at least one of the first and the second modulators, the polarization controller changing the polarization state of the modulated optical pulse train.

8. The multiplexer of claim 1 wherein the optical combiner comprises an optical polarization beam combiner.

9. The multiplexer of claim 1 wherein the optical combiner comprises a coupler.

10. The multiplexer of claim 1 wherein at least one of the first and the second modulators comprise an electro-optic modulator.

11. The multiplexer of claim 10 wherein the electro-optic modulator comprises a Mach-Zehnder interferometric modulator.

12. The multiplexer of claim 1 wherein at least one of the first and the second modulators comprises an electro-absorption modulator.

13. The multiplexer of claim 1 further comprising a directly modulated laser that generates the optical signal.

14. The multiplexer of claim 1 further comprising a continuous wave (CW) laser and an external modulator that generates the optical signal.

15. The multiplexer of claim 1 wherein at least one of the first and the second modulator comprises a pulse carving modulator.

16. The multiplexer of claim 1 wherein the first and the second modulators and the optical polarization beam combiner are discrete components that are optically coupled with optical fiber.

17. The multiplexer of claim 1 wherein the multiplexer comprises an integrated lightwave circuit.

18. The multiplexer of claim 1 further comprising a dither signal generator that is electrically coupled to the electrical modulation signal input of one of the first and the second modulators, the dither signal generator superimposing a dither signal on the electrical modulation signal, thereby marking the modulated optical pulse train with the dither signal.

19. The multiplexer of claim 18 further comprising:
a. a detector that is positioned to detect a portion of the polarization multiplexed optical pulse train, the detector generating at an output an electrical signal having the superimposed dither signal; and
b. an electronically variable phase delay generator having an input electrically coupled to the output of the detector and an output electrically coupled to a control input of an electrical modulation source that is electrically coupled to the electrical modulation signal input of one of the first and the second modulators,
wherein the electronically variable phase delay generator generates a signal that changes a phase of the electrical modulation signal generated by the electrical modulation source.

20. The multiplexer of claim 19 wherein the phase of the electrical modulation signal is changed to position pulses in the polarization multiplexed optical pulse train in a desired relative order.

21. The multiplexer of claim 18 further comprising:
a. a detector that is optically coupled to a complementary port of one of the plurality of modulators, the detector detecting a portion of the polarization multiplexed optical pulse train and generating at an output an electrical signal having the superimposed dither signal; and
b. an electronically variable phase delay generator having an input electrically coupled to the output of the detector and an output electrically coupled to a control input of an electrical modulation source that is electrically coupled to the electrical modulation signal input of one of the first and the second modulators,
wherein the electronically variable phase delay generator generates a signal that changes a phase of the electrical modulation signal generated by the electrical modulation source.

22. The multiplexer of claim 21 wherein the phase of the electrical modulation signal is changed to position pulses in the polarization multiplexed optical pulse train in a desired relative order.

23. The multiplexer of claim 1 further comprising a variable optical delay that is optically coupled between the output of one of the first and the second modulators and one of the first and second inputs of the optical polarization beam combiner, the variable optical delay adjusting the relative position of the pulses in the polarization multiplexed optical pulse train.

24. The multiplexer of claim 23 wherein the variable optical delay continuously adjusts the relative position of the pulses in the polarization multiplexed optical pulse train.

25. A method of generating a polarization multiplexed optical pulse train, the method comprising:
a. modulating a first and a second optical signal with a first and a second electrical modulation signal, respectively, thereby generating a first and a second modulated optical pulse trains, a phase of the first electrical modulation signal being independently adjustable relative to the phase of the second electrical modulation signal; and
b. combining the first and the second modulated optical pulse trains into a polarization multiplexed optical pulse train,
wherein a relative position of each pulse in the pulse train being determined by the optical path length propagated by the pulse and a relative order of each pulse in the pulse train being determined by a relative phase of the modulation signal that generated the pulse.

26. The method of claim 25 wherein the first and the second optical signals are substantially the same optical signal.

27. The method of claim 25 wherein the polarization multiplexed optical pulse train comprises time overlapping polarization multiplexed optical pulses.

28. The method of claim 25 wherein the polarization multiplexed optical pulse train is linearly polarized.

29. The method of claim 25 wherein the polarization multiplexed optical pulse train is orthogonally polarized.

30. The method of claim 25 wherein the polarization multiplexed optical pulse train is substantially periodic.

31. The method of claim 25 further comprising adjusting a phase of one of the first and the second electrical modulation signals to change the relative order of pulses propagated in the polarization multiplexed optical pulse train.

32. The method of claim 25 further comprising modulating at least one of the first and the second optical signals with a sustained switching voltage, thereby dropping a channel.

33. The method of claim 25 wherein the electrical modulation signal comprises a train of electrical packets propagating at data rate R and the phase of the packets is chosen so that each bit is combined in optical packets at data rate NR, where N is the number of channels.

34. A polarization division multiplexer comprising:
a. a plurality of modulators, each of the plurality of modulators having an optical input that receives an optical signal, an electrical modulation signal input that receives an electrical modulation signal, and an optical output, each of the plurality of modulators modulating the electrical modulation signal onto the optical signal and generating a modulated optical pulse train at the respective optical output;
b. at least one optical bit interleaving combiner, each of the at least one bit interleaving combiners having a plurality of optical inputs and an optical output, a respective one of the plurality of optical inputs of the bit interleaving combiner being optically coupled to a respective one of the optical outputs of the plurality of modulators, the at least one bit interleaving combiners generating a first and a second bit interleaved optical pulse train at a first and a second optical output, respectively; and
c. an optical beam combiner having a first and a second optical input and an optical output, a respective one of the first and the second optical input of the beam combiner being optically coupled to the first and the second optical output of the at least one bit interleaving combiners, the optical beam combiner combining the modulated optical bit stream generated by each of the plurality of modulators into a polarization multiplexed optical pulse train,
wherein a relative position of each pulse in the polarization multiplexed optical pulse train is determined by an optical path length propagated by the pulse and a relative order of each pulse in the polarization multiplexed optical pulse train is determined by a relative phase of the modulation signal that generated the pulse.

35. The multiplexer of claim 34 wherein the optical combiner comprises an optical polarization beam combiner.

36. The multiplexer of claim 34 wherein the optical combiner comprises a polarization maintaining coupler.

37. The multiplexer of claim 34 wherein the optical combiner comprises a coupler.

38. The multiplexer of claim 34 farther comprising a plurality of electrical modulation sources, a respective one of the plurality of electrical modulation sources having an output that is electrically coupled to an electrical modulation signal input of a respective one of the modulators.

39. The multiplexer of claim 38 wherein at least one of the plurality of electrical modulation sources generates a modulation signal with a phase that is independent of the phase of modulation signals generated by the other electrical modulation sources.

40. The multiplexer of claim 34 further comprising a polarization controller that is optically coupled to the output of at least one of the plurality of modulators, the polarization controller changing the polarization state of the modulated optical pulse train.

41. The multiplexer of claim 34 wherein at least one of the plurality of modulators comprises an electro-optic modulator.

42. The multiplexer of claim 34 wherein the electro-optic modulator comprises a Mach-Zehnder interferometric modulator.

43. The multiplexer of claim 34 wherein at least one of the plurality of modulators comprises an electro-absorption modulator.

44. The multiplexer of claim 34 further comprising a directly modulated laser that generates the optical signal.

45. The multiplexer of claim 34 further comprising a continuous wave (CW) laser and an external modulator that generates the optical signal.

46. The multiplexer of claim 34 wherein at least one of the plurality of modulators comprises a pulse carving modulator.

47. The multiplexer of claim 34 wherein the plurality of modulators and the optical beam combiner are discrete components that are coupled together with optical fiber.

48. The multiplexer of claim 34 wherein the multiplexer comprises an integrated lightwave circuit.

49. The multiplexer of claim 34 further comprising a dither signal generator that is electrically coupled to the electrical modulation signal input of one of the plurality of modulators, the dither signal generator superimposing a dither signal on the electrical modulation signal, thereby marking the modulated optical pulse train with the dither signal.

50. The multiplexer of claim 49 further comprising:
a. a detector that is positioned to detect a portion of the polarization multiplexed optical pulse train, the detector generating at an output an electrical signal having the superimposed dither signal; and
b. an electronically variable phase delay generator having an input electrically coupled to the output of the detector and an output electrically coupled to a control input of an electrical modulation source that is electrically coupled to the electrical modulation signal input of one of the plurality of modulators,
wherein the electronically variable phase delay generator generates a signal that changes a phase of the electrical modulation signal generated by the electrical modulation source.

51. The multiplexer of claim 50 wherein the phase of the electrical modulation signal is changed to position pulses in the polarization multiplexed optical pulse train in a desired relative order.

52. The multiplexer of claim 34 further comprising a variable optical delay that is optically coupled between the output of one of the plurality of modulators and the input of optical polarization beam combiner, the variable optical delay adjusting the relative position of the pulses in the polarization multiplexed optical pulse train.

53. The multiplexer of claim 52 wherein the variable optical delay continuously adjusts the relative position of the pulses in the polarization multiplexed optical pulse train.

54. A method of generating a polarization multiplexed optical pulse train, the method comprising:
a. modulating a plurality of optical signal with a plurality of electrical modulation signal, thereby generating a plurality of modulated optical pulse trains, a phase of at least one of the plurality of electrical modulation signal being independently adjustable relative to the phase of the other electrical modulation signal;
b. combining plurality of modulated optical pulse trains into a first and a second bit interleaved optical pulse trains; and;
c. combining the first and the second bit interleaved optical pulse trains into a polarization multiplexed optical pulse train,
wherein a relative position of each pulse in the pulse train being determined by the optical path length propagated by the pulse and a relative order of each pulse in the pulse train being determined by a relative phase of the modulation signal that generated the pulse.

55. The method of claim 54 wherein the first and the second optical signals are substantially the same optical signal.

56. The method of claim 54 wherein the polarization multiplexed optical pulse train comprises time overlapping polarization multiplexed optical pulses.

57. The method of claim 54 wherein the polarization multiplexed optical pulse train is orthogonally polarized.

58. The method of claim 54 wherein the polarization multiplexed optical pulse train is substantially periodic.

59. The method of claim 54 further comprising adjusting a phase of one of the plurality of electrical modulation signals to change the relative order of pulses propagated in the polarization multiplexed optical pulse train.

60. The method of claim 54 further comprising modulating at least one of the first and the second optical signals with a sustained switching voltage, thereby dropping a channel.

61. The method of claim 54 wherein the electrical modulation signal comprises a train of electrical packets propagating at data rate R and the phase of the packets is chosen so that each bit is combined in optical packets at data rate NR, where N is the number of channels.
